(19) United States
(12) Patent Application Publication
(10) Pub. No.: US 2020/0143950 A1
(43) Pub. Date: May 7, 2020

(54) Utilizing Decay Heat via Steam Cycles to Produce Electric Power on Site to Eliminate Accidents Caused by Station Blackout in Nuclear Power Plants

(71) Applicants: Jiatsong Jason Chao, Cupertino, CA (US); David Heywood Johnson, Las Cruces, NM (US)

(72) Inventors: Jiatsong Jason Chao, Cupertino, CA (US); David Heywood Johnson, Las Cruces, NM (US)

(21) Appl. No.: 16/019,419

(22) Filed: Jun. 26, 2018

(51) Int. Cl. G21D 1/00; G21C 15/18; F22B 33/18; G21D 3/04

(52) U.S. Cl. CPC G21D 1/006; G21D 3/04; F22B 33/18; G21C 15/18

(57) ABSTRACT

This invention fundamentally changes the basic design principles adopted over the last 50 years that addresses the basic root cause for the station blackout threat faced by all nuclear power plants. The Fukushima nuclear accident that occurred in Japan in 2011 could have turned benign had the plant implemented this invention. It uniquely utilizes the decay heat directly from the reactor core through steam cycles to produce useable power onsite with one or a number of steam turbines of less capacities in combination with compatible electric generators. Such arrangement is reliable to be the onsite energy source. The electric power produced by generators attached to these steam turbines could support necessary all safety functions. The result is that during the first week of urgent threat to the nuclear reactor, there will always be electric power available to run the safety equipment, computers, lighting and other vital devices continuously.

### BACKGROUND OF THE INVENTION

### Technical Field

This invention addresses a needed feature for all nuclear power plant designs, existing in operation and future new concepts, cooled by water or by any other coolants, fueled by Uranium, Plutonium, Thorium, or any other nuclear fissile materials, pressurized water reactors (PWRs), boiling water reactors (BWRs), fast breeder reactors (FBRs), or any other types, moderated or cooled by water or by heavy water, so long as the decay heat is generated in the nuclear core.

### Background Art

The nuclear accident occurred at Fukushima on Mar. 11, 2011 revealed and confirmed the fact that when a nuclear plant is challenged by an unexpected event and has to shut down three basic elements must exist to avoid a nuclear accident arising from the failure to remove decay heat. These three elements are water (coolant), means to deliver water to reactor core, and electric power. These three basic items are needed to cool the nuclear reactor core by removing the nuclear decay heat.

During the Fukushima accident the plant operator failed to utilize the sea water in time in lieu of the swept away stored water. In less than a day without the water for cooling the progression toward a nuclear accident became irreversible. A plant building blew up on the third day due to lack of water, fail to deliver water and no electric power, the missing of the three said elements.

There are prior arts to address the first two items. But there has been no prior art to address the third item, the electric power using the steam generated by the decay heat directly to drive a steam turbine and a generator to produce electricity. This patent is an invention to address the third item, the electric power, required for the safe shut down of a nuclear plant.

Unique Nature of this Invention

The unique nature of this invention is that it corrects a 50 year old misconception by nuclear engineers that has existed since the inception of nuclear power plants. The misconception is that the decay heat is something that must be removed and if not removed properly effectively and efficiently it will cause damages to the plant and radioactive materials will be released and cause a catastrophe. The decay heat has been viewed as something that could only be an antagonist and never a benefactor.

No engineers has ever designed a system to utilize the decay heat as an energy source to product the power that satisfy the 3^{rd} required element for a safe shut down of a nuclear plant. The unique nature of this invention is to take the decay heat as a benefactor by utilizing it in a positive manner and by overcoming certain engineering impediment for producing electricity onsite such that the SBO scenario would not happen.

### Station Blackout the Most Dangerous Scenario

The SBO scenario among all identified possible causes for a nuclear accident is the most probable and damaging cause for a nuclear accident in today's nuclear power plants. The Fukushima Accident was an extended SBO scenario initiated by the tsunami and progressed into a disaster due to lack of sustainable water supply and failure to resume the power required to operate vital equipment. Both statistics and analyses substantiate the observation that the SBO is a most dangerous scenario in a nuclear plant. While the SBO scenario is the most probable severe challenge to the integrity of the reactor fuel, it is by no means the only scenario that would significantly benefit from the invention.

### Recognition of Risk Importance of Station Blackout (SBO) and Loss of Offsite Power

The risk significance of the loss of offsite power has been recognized since at least the publication of the 1975 Reactor Safety Study (Reference 1). That landmark comprehensive safety analysis identified reactor transients involving loss of offsite power as one of the three types of scenarios contributing significantly to the frequency of fuel damage. Virtually all comprehensive plant-specific risk assessments performed since have confirmed and strengthened this conclusion. Many of these subsequent studies have further identified station blackout events as being major contributions to risk.

SBOs are not rare events. The U.S. Nuclear Regulatory Commission (NRC) reviewed loss of offsite power events that occurred at US nuclear power plants between 1980 and 1996 (Reference 2) and identified sixteen SBO events—two of which occurred when the reactors were at power. As cooling is required long after the plant is shutdown—as was the case at Fukushima—the events that occurred while the plant was not in operation cannot be readily dismissed as risk free.

In the late 1980s, the NRC performed risk assessments for several specific plants. The results for Peach Bottom 2 (Reference 3), a plant similar to Fukushima Dai-ichi units 2, 3 and 4, indicated that station blackout contributed approximately 49% of the core damage frequency from internally initiated events. These ‘internal’ events are those plant upsets that originate within the plant systems and do not include externally initiated causes such as tsunami, earthquakes or severe weather events. Externally initiated events typically have a higher potential to result in station blackout; their inclusion would likely increase the percentage of damage sequences characterized by station blackout.

The Sequoyah and Surry nuclear power plants are of a very different design than the boiling water reactors such as Peach Bottom or Fukushima units. These plants are pressurized water reactors. Together with boiling water reactors, pressurized water reactors represent the great majority of nuclear power plants worldwide. The NRC assessments of these plants (References 4, 5) indicated that station blackout contribute 26% and 68% of the core damage frequency due to internally initiated events, respectively. The Sequoyah study also provided additional details regarding the nature of the station blackout scenarios. For example, in some 30% of the SBO events, the fuel is damaged after cooling of the reactor coolant pump seals is lost. Failure of the seals results in an uncontrolled leak of reactor cooling water.

Grand Gulf, a boiling water reactor of more recent design than those found at Peach Bottom or Fukushima Dai-ichi, was another reactor studied by NRC (Reference 6) during this period. The Grand Gulf analysis indicated that 98% of the core damage frequency from internally initiated events is due to SBO.

In approximately this same timeframe, the owner-operators of US nuclear power plants performed independent probabilistic risk assessments. The results of those assessments were summarized by NRC (Reference 7). Those assessments indicated that the risk due SBO was important for most plants. For early vintage boiling water reactors (Fukushima Dai-ichi unit 1 would be in this category), SBO was dominate, contributing up to 65% of core damage frequency, for those plants that did not have specialized systems to mitigate the event. For boiling water reactors of the Peach Bottom vintage as well as the Grand Gulf vintage, SBO was important for most plants and contributed up to 90% of core damage frequency. For pressurized water reactors, SBO represented an important class of events leading to core damage, with loss of reactor seal cooling of special concern.

Further evidence that SBO events are not rare was presented at a 2013 IAEA workshop (Reference 8). This evidence included summarizing the following events:
Damage caused by a typhoon resulted in a station blackout at unit 4 at Kori (Japan) in 1986. The design of this plant permitted natural circulation of the primary coolant facilitating heat removal
A main turbine failure resulted in a turbine blade ejection causing a fire and hydrogen explosion at unit 1 at Narora (Japan). The scenario degraded into a station blackout that lasted 17 hours.

Following the East Japan Great Earthquake, Fukushima Dai-ichi was not the only nuclear plant that was challenged (Reference 9). Fukushima Dai-ini was also impacted, and a single offsite power supply prevented the loss of offsite power at this site from degrading to become a SBO event. Units 5 and 6 at Fukushima Dai-ichi were able to maintain an innovative electrical configuration that allowed them to share the power from a single remaining diesel generator. Other units in Japan—Higashidori, Onagawa and Tokai—experienced degraded offsite power.

### On-Site Equipment Failure

The Forsmark-I unit in Sweden experienced a fault in its switchyard resulting in an electrical disturbance causing a loss of offsite power on 25 Jun. 2006 (Reference 10). Two of the unit's diesel generators failed to start due to failures of two power supplies caused by the same electrical disturbance.

A second example of onsite equipment failure leading not just loss of offsite power with degraded emergency power, but actual SBO occurred in 1990 at unit 1 of the Vogtle plant in Georgia (Reference 11). A maintenance truck in the switchyard hit a support resulting in a loss of offsite power. One emergency diesel generator was in maintenance and the second diesel tripped after less than 2 minutes of operation. A SBO resulted. Power was restored in 36 minutes.

### External Flooding

The 1999 flood at the French nuclear power plant Blayais (Reference 12) has been referred to as the precursor to Fukushima. The plant was built on an estuary that had experienced flooding dating back to 585 AD. With three of the four units at the site operating, an incoming tide combined with high winds. One unit experienced a partial loss of offsite power while the other two operating units experienced a complete loss of offsite power. Flood waters entered the plant failing half of the service water system necessary for the safety systems to operate. French nuclear safety experts estimated that if the service water system had completely failed, core damage may have occurred after 10 hours.

The potential danger of external flooding was highlighted by the NRC in 1994 (Reference 13). That formal announcement by the NRC summarized the events of June and July 1993 when flood waters rose surrounding the Cooper Nuclear Station in Nebraska. Cooper is of similar design to the Fukushima units that were damaged. While offsite power was not lost, access to the plant was restricted by raising flood waters, and, more importantly, water seeping into the plant damaged the controls of the reactor core isolation cooling system (a system important in responding to a station blackout challenge). Water was leaking onto safety related cable trays and on control boxes. Had offsite power been lost—an event that happens on the order of once in ten years at a typical site—the scenario would have potentially been very different.

### Human Error

While in a refueling outage on 9 Feb. 2012 (Reference 14), an error made while testing relays resulted in the loss of offsite power at the Kori-1 unit in Korea. One diesel failed to start and the second diesel was out of service in planned maintenance. The result was a station blackout lasting for 19 minutes. During this time, the temperature in the hot leg rose over 20° C.

### High Winds

On 27 Apr. 2011 (References 15, 16), severe weather with high winds, including tornados, resulted in the loss of all 500 kV and one of two 161 kV offsite transmission lines at the three unit Browns Ferry Nuclear Plant in Alabama. Onsite emergency diesel generators, except one that was undergoing planned maintenance, functioned normally to provide emergency power. Restoration of offsite power required extensive repair of the transmission lines and was accomplished on 2 May.

In 1992, the category 4 Hurricane Andrew caused extensive onsite and offsite damage to the Turkey Point site in Florida (References 17, 18). In anticipation of the storm, the two nuclear units were placed in hot shutdown condition. Nevertheless, this condition still requires active cooling of the reactor fuel. All offsite power was lost for 4 days. The non-safety water storage tank fell during the storm and damaged the fire protection system—a potentially important source of emergency cooling that became unavailable. The access to the site is via a single road which was blocked by debris thereby hindering assistance from offsite. All offsite communication was inoperable for 4 hours, emphasizing the necessity of having robust coping capability onsite. Access was not established via this road until day 2 of the event. Communication systems were inoperable. The situation could have been more challenging as a severely damaged exhaust stack for the adjacent fossil power plant threatened to fall on the diesel generator building.

A key attribute of the invention described here is that it has not been designed to address a narrow range of specific causes of the threat to the plant. The invention would have offered a significant remedial safety system, specifically one that would not have relied on outside resources to reach the plant, which would have reduced the risk in each of the diverse scenarios described above. The invention does not rely on regional sharing of equipment or emergency access to the site. Each unit is independently and individually protected.

Prior Arts for Delivering the 1^{st} and 2^{nd} Requirements for Mitigating SBO

This invention addresses the 3^{rd} requirements, a missing element for mitigating the SBO scenario which is a revolutionary concept. All related prior arts address the 1^{st} and the 2^{nd} (2 of the 3) requirements for mitigating the SBO scenario.

The 1^{st} requirement is to store enough water on site as the coolant. Prior arts address this requirement by designs of an Isolation Condenser for BWRs, Condensates Storage Tanks for BWRs and PWRs, Torus suppression pool in BWRs, and the gravity drain tank in AP1000 and ESBWRs. Several prior arts address the 1st requirement of using onsite stored water for cooling purposes are given in References 19-29.

The 2^{nd} requirement is to deliver water and steam to secure the cooling process to take the decay heat away. Prior arts address this requirement by designs of Reactor Core Isolation Cooling (RCIC) system and High Pressure Cooling Injection (HPCI) in BWRs and passive cooling via gravity driven water delivery to an AP1000 (PWR) and ESBWR containment. Several prior arts address the 2nd requirement of methods of delivering water for cooling purposes are given in References 30-41.

### REFERENCES

1. USNRC, Reactor Safety Study; An Assessment of Accident Risks in US Commercial Nuclear Power Plants, WASH-1400, Appendix V, page V-45, October 1975.
2. USNRC, Evaluation of Loss of Offsite Power Events at Nuclear Power Plants: 1980-1996, NUREG/CR-5496, November 1998.
3. USNRC, Analysis of Core Damage Frequency: Peach Bottom unit 2 Internal Events, NUREG/CR-4550 vol 4, rev 1, part 1, August 1989.
4. USNRC, Analysis of Core Damage Frequency: Sequoyah unit 1 Internal Events Appendices, NUREG/CR-4550, vol 5, rev 1, part 1, April 1990.
5. USNRC, Analysis of Core Damage Frequency: Surry unit 1 Internal Events, NUREG/CR-4550, vol 3, rev 1, part 1, April 1990.
6. USNRC, Analysis of Core Damage Frequency: Grand Gulf unit 1 Internal Events, NUREG/CR-4550, vol 6, rev 1, part 1, November 1989.
7. USNRC, Individual Plant Examination Program: Perspectives on Reactor Safety and Plant Performance, NUREG-1560, vol 2, parts 2-5, Final Report, December 1997.
8. IAEA, Thomas Koshy, Redundancy and Diversity Lessons, Nuclear Power Technology Assessment, 24-28 Jun. 2013, http://www.iaea.org/NuclearPower/Downloadable/Meetinqs/2013/2013-06-24-06-28-TM-NPTD/19-iaea-redundancy-diversity-lessons.pdf.
9. Report of the Japanese Government to the IAEA Ministerial Conference on Nuclear Safety, The Accident at TEPCO's Fukushima Nuclear Power Station, June 2011, japan.kantei.go.jp/kan/topics/201106/iaea_houkokusho_e.html.
10. Status of OECD/NEA country Regulatory Responses to the Forsmark-I Event of 25 Jun. 2006 and NEA/CSNI DiDELSYS Task Group Recommendations, NEA/CNRA/R (2011) 8, December 2010. http://www.oecd-nea.org/nsd/docs/2011/cnra-r2011-8.pdf.
11. USNRC, Information Notice 90-25: Loss of Vital AC Power with Subsequent Reactor Coolant System Heat-Up, Apr. 16, 1990, http://www.nrc.gov/reading-rm/doc-collections/gen-comm/info-notices/1990/in90025.html.
12. 1999 Blayais Nuclear Power Plant Flood, Wikipedia, http://en.wikipedia.org/wiki/1999_Blayais_Nuclear_Power_Plant_flood.
13. USNRC, Information Notice 94-27: Facility Operating Concerns Resulting in Local Area Flooding, Mar. 31, 1994, http://www.nrc.gov/reading-rm/doc-collections/gen-comm/info-notices/1994/in94027.html.
14. Report of the EXPERT MISSION to Review the Station Blackout Event that Happened at Kori 1 NPP on 9 Feb. 2012, IAEA, NSNI Expert Mission, 4-11 Jun. 2012.
15. USNRC, Event Notification Report for Apr. 28, 2011, http://www.nrc.gov/reading-rm/doc-collections/event-status/event/2011/20110428en.html#en6793.
16. Tennessee Valley Authority, Licensee Event Report 50-259/2011-002-00, 27 Jun. 2011.
17. USNRC, Information Notice 93-53; Effect of Hurricane Andrew on the Turkey Point Nuclear Generating Station from Aug. 20-30, 1992.
18. Joint Report by the Institute of Nuclear Power Operations and the US Nuclear Regulatory Commission, March 1993.
19. Patent Application 20180047469, Component Cooling Water System for Nuclear Power Plant.
20. Patent Application 20150170772, Cooling Water System for Nuclear Power Plant.
21. Patent Application 20140205051, Passive System for Cooling the Core of A Nuclear Power Plant.
22. Patent Application 20140003567, Nuclear Power Plant and Passive Containment Cooling System.
23. Patent Application 20130235966, Emergency Core Cooling System and Boiling Water Nuclear Plant
24. Patent Application 20130223581, Nuclear Power Plant
25. US20120294737, Autonomous Self-Powered System for Removing Thermal Energy from Pools of Liquid Heated by Radioactive Materials and Methods of the Same
26. Patent Application 20120294408, Passive Emergency Feedwater System
27. Patent Application 20120177168, Passive Emergency Feedwater System
28. Patent Application 20090129530, Passive Emergency Feedwater System
29. Patent Application 20140112426, Passive Residual Heat Removal System and Nuclear Power Plant Equipment
30. Patent Application 20140003567, Nuclear Power Plant and Passive Containment Cooling System
31. Patent Application 20130272473, Auxiliary Condenser System for Decay Heat Removal in Nuclear reactor
32. Patent Application 20130235966, Emergency Core Cooling System and Boiling Water Nuclear Plant
33. Patent Application 20130223581, Nuclear Power Plant
34. US20120294737, Autonomous Self-Powered System for Removing Thermal Energy from Pools of Liquid Heated by Radioactive Materials and Methods of the Same
35. Patent Application 20120294408, Passive Emergency Feedwater System
36. Patent Application 20120177168, Passive Emergency Feedwater System
37. Patent Application 20090129530, Passive Emergency Feedwater System
38. Patent Application 20180023423, Autonomous Self-Powered System for Removing Thermal Energy from Pools of Liquids Heated by radioactive Materials and Methods of the Same
39. Patent Application 20170162282, Passive Containment Heat Removal System and Control method Thereof
40. Patent Application 20160118147, Passive System for Cooling the Core of a Nuclear
41. Patent Application 20150131770, Emergency Core Cooling System and Emergency Core Cooling Method for Fail-Safe Water-Cooled Reactor System

### BRIEF SUMMARY OF THE INVENTION

### Technical Problem

The SBO is the most threatening scenario to the safety of a nuclear power plant. This is because that when a nuclear plant encounters an unexpected or undesirable situation, it is a common practice that the plant shuts down quickly for safety measures, possibly resulting in the loss of normal and emergency power. Such condition could be caused by an external event such as a flood, storm, hurricane, earthquake, or somehow the off-site power is cut off and the on-site equipment failed to start or other causes such as human errors.

When any of these situations occur, the power plant should be shut down, either by predetermined procedures, automatic plant actions or at the discretion of operation staff with correct diagnosis for the situation. When a nuclear power plant is shut down, the main and immediate objective is to cool the reactor core as the decay heat inherently produced in the nuclear fuel will always be there. If the decay heat is not addressed properly, fuel elements could be melt and radioactive materials could be released to the environment, or the fuel elements that are clad in metals could interact with high temperature water and steam to generate hydrogen gas. The hydrogen gas would escape via any possible means to environment outside the reactor and cause explosion. This generation of hydrogen was why the Fukushima plant reactor building exploded.

When the nuclear plant faces a shut down, there are three required means to cool down the plant, (1) the water, (2) a mechanism to deliver the water to the reactor core, (3) and the electric power to run the safety equipment such as water pumps, the vital computers that control certain critical automated logics and instruments, and the lights in the control room for operators.

This invention addresses the 3rd means, the electric power supply in a nuclear plant when a station blackout occurs.

There are three ways to deliver electric power to the plant when a station black occurs in existing nuclear power plants. The main means is to rely on the off-site power which is a power line that would transmit power from off site to the nuclear plant. The second means is to rely on the on-site diesel generators to generate electricity for on-site use, and the third means is to use the installed batteries.

When the tsunami hit the Fukushima plant, it knocked down the water tanks, sheared the power line that could otherwise deliver the electricity as the off-site power. The tsunami severely damaged the Diesel generators at the same time. Only the batteries were potentially able to deliver electricity. The batteries were drained after 8 hours of use. From the point that the batteries were drained, the scenario turned into a genuine SBO. It is also possible that some batteries were failed due to water inundation. The point being that normal and emergency DC power was lost at a critical point in the Fukushima accident.

The summoned fire trucks at the Fukushima tried to deliver the water into the reactor containment buildings but it ran into too many technical difficulties and it was too late. The plant staff had spent days to lay a new power line to connect with the off-site power which took 8 days to finish the job and it was too late. The first five days are the most critical time frame for a nuclear plant to reach a safe state.

### Solution to Problem

The decay heat is an energy source which is a strong enough to produce electricity onsite such that there will never be a SBO in a nuclear plant. This idea has never been adopted because that the decay heat decreases exponentially and has never been viewed as a constant and therefore never a reliable source to utilize for electricity production purposes on site. However, the non-constant nature of such energy source can be handled by this invention through a cascade arrangement of piping configurations in combination of a suitable number of turbines and generators. With such invented arrangements, the decay heat will always be utilized as the intrinsic electricity source such that a SBO would never occur in a nuclear power plant. In the history of nuclear power plant design and operation, the decay heat had been always viewed as an antagonist rather than a benefactor until this invention.

### Advantageous Effect of the Invention

Had this invention been implemented and with the sea water available on site, the Fukushima accident could have been avoided entirely. The most vulnerable condition to a nuclear power plant is hereby fundamentally addressed. The reliability of a nuclear power plant is increased significantly by this invention. The safety of nuclear power plants will be significantly enhanced.

The vulnerability in the availability and reliability of the off-site power, batteries and Diesel generators would no longer be a threat. The stringent requirements for startup tests of Diesel generators would no longer be as necessarily harsh and demanding as before. With the electric power available constantly, there would be always means to deliver water to reactor core when needed. The feature of the gravity driven water is therefore no longer a design prerequisite which would alleviate the seismic concerns for installing water storage pools at high elevations.

The invention also delivers additional safety benefits. While designed with SBO or near SBO conditions in mind, the addition of an additional source of electric power, both AC and DC, will result in reducing the likelihood of severe plant damage in non SBO accidents.

### BRIEF DESCRIPTION OF THE DRAWINGS

FIG. 1 shows the characteristics of the decay heat that is decreasing with time.

FIG. 2 is a structural diagram showing a boiling water reactor based nuclear power plant according to Embodiment 1.

FIG. 3 is a structural diagram showing a pressurized water reactor based nuclear power plant according to Embodiment 2.

FIG. 4 is a structural diagram showing the major equipments and devices with required arrangements and needed rechargeable batteries to eliminate the station blackout conditions for a nuclear power plant according to Embodiment 3.

FIG. 5 is a structural diagram showing the major equipments and devices with required arrangements and the needed multistage steam turbine to eliminate the station blackout conditions for a nuclear power plant according to Embodiment 4.

### DETAILED DESCRIPTION OF THE INVENTION

### Detailed Description of the Preferred Embodiments

### Working Principles

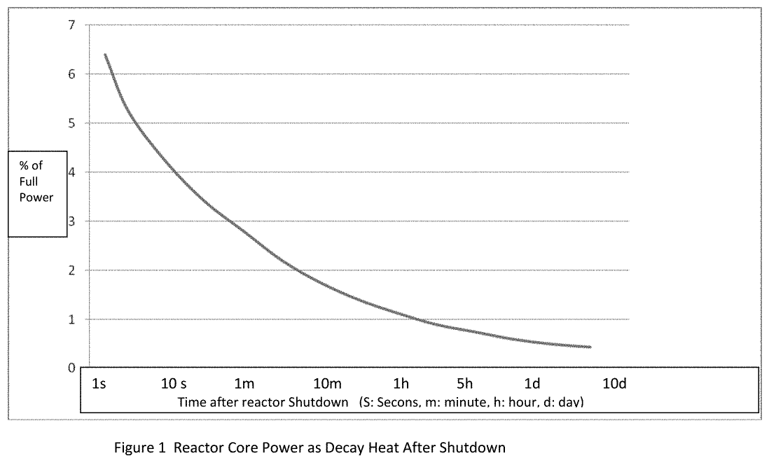

When the reactor in a nuclear power plant is shut down, the initial decay heat level is rough at 6.5% of the previous operating power. Then it will decrease exponentially with time. The heat level will decrease to 1.5% in an hour, to 0.4% at the end of the first day, and to rough 2% at the end of a week. For a typical 1000 MWe nuclear plant, at the end of 3^{rd} day the decay heat could still be available to generate electricity at roughly 2.8 MWe which is a significant power level for use on site. This invention overcomes the perceived impediments for utilizing the decay heat for this purpose. A decay heat of decreasing nature is illustrated by FIG. 1.

The engineering principle for this invention is illustrated by the arrangements described in the next example which is applicable to BWRs as well as PWRs. While only BWR and PWR examples are given, the invention is equally applicable to any reactor designs using water or heavy water as either the primary or secondary coolant.

For the first day after the reactor is shut down, at the end of the day the decay heat level will be at 0.5% of the full power level. A control system will set up and manage the arrangement that the steam produced during the first day either from a BWR directly or from steam generators of a PWR is channeled to a set of a multistage small size of turbine connected to generators to produce electricity. The number of the turbines and the streamlined generators used to produce electricity depends on the capacities adopted for this application. The generators are elected to be compatible with the amount of steam produced during the first day of shut down such that the steam production shall match with the electricity output that the five generators are capable of producing.

### Embodiment 1

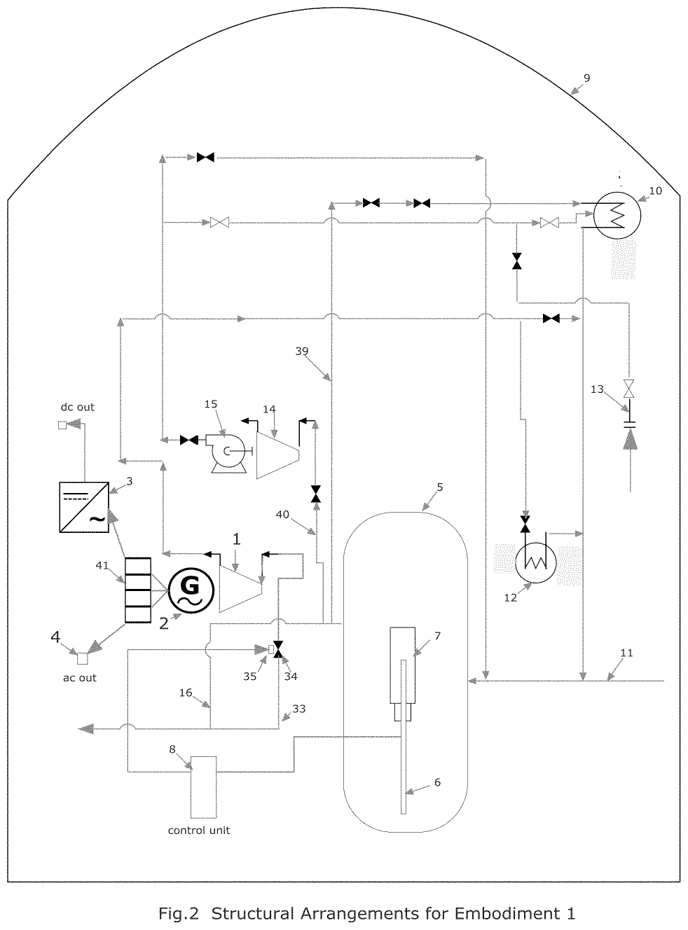

A nuclear power plant based on a boiling water reactor consists of a reactor vessel 5 with a reactor core 7. The reactor vessel is housed in a reactor containment as shown in FIG. 2. The feedwater lines 11 are delivering water to the reactor vessel to cool the reactor core 7. The heat generated by the reactor core 7 will convert the water inside the reactor vessel to steam. The steam produced in the reactor core 7 will go forward in the main steam line 16 and eventually to the main turbine that connected to the main generator to produced the electricity.

A branched off steam line 39 is directed to an Isolation Condenser 10 for passive cooling. Another branched off steam line is also designed to drive a steam driven turbine that could drive water pumps for other engineering applications. Note that not all BWRs incorporate an Isolation Condenser in their design as is discussed in the current example. Some include turbine driven standby emergency pumps (e.g., Reactor Core Isolation Cooling and/or High Pressure Coolant Injection). The invention is equally applicable to these BWR design variants.

The devices and equipment for this invention are added in a new branched off steam line 33, that is branched off the main steam line 16. A control valve 34 is installed as a switch to control the steam flow in Line 33. A valve control unit 35 is designed to take the control signals from Control Unit 8 that relies on the control rods that control the reactor power.

The branched off steam line 33 will be fed into a specially designed turbine 1 uniquely added for this invention. The turbine 1 is connected to a special generator 2 that produces electricity by the motion of the generator. The turbine 1 and the generator 2 are utilizing the steam generated by the decay heat to generate electricity such that the station blackout would never occur in a nuclear power plant.

The generator 2 that produces electricity is connected to an array arrangement 41. The electricity is then distributed by the array arrangements to the direct current (DC) buses 3 and the alternating current (AC) buses 4 for the electric equipments used in the plants.

### Embodiment 2

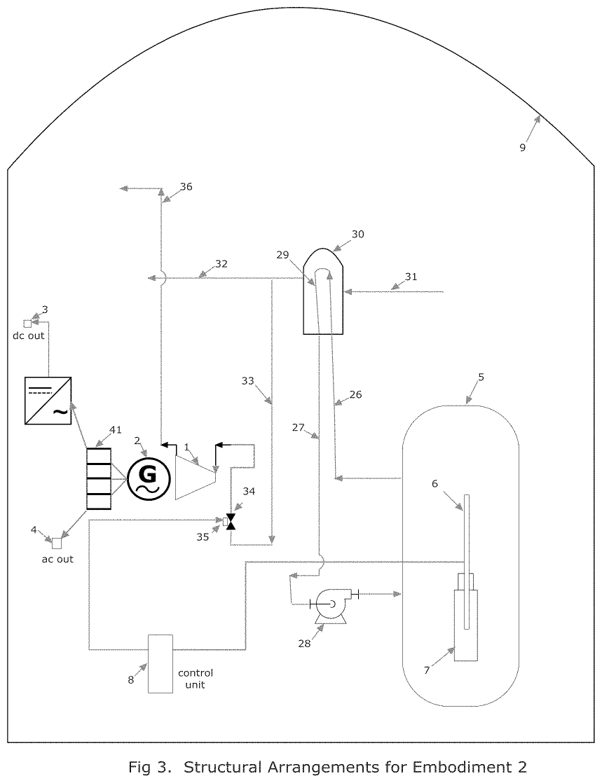

A nuclear power plant based on a pressurized water reactor consists of a reactor vessel 5 with a reactor core 7. The reactor vessel is housed in a reactor containment as shown in FIG. 3. The hot legs 26 will take the coolant heated by the core 7 through steam generator tubes to steam generators 30 in which steam is produced. After the steam is generated and the coolant is cooled down by having transferred heat to steam generators, the coolant will be diverted to the cold legs through the pumping efforts by the Reactor Coolant Pumps 28 and the coolant will be further delivered into the reactor pressure vessel 5.

The feedwater lines 31 supply water to steam generators 30. The steam is produced utilizing the heat inside the steam generator tubes 29 from the water delivered from the feedwater lines 31. The produced steam is then sent through the main steam line 32 to the main turbine (not shown) connected to the main generators (not shown).

The unique devices and equipment for this invention are added in a new branched off steam line 33, that is branched off the main steam line 32. A control valve 34 is installed as a switch to control the steam flow in Line 33. A valve control unit 35 is designed to take the control signals from Control Unit 8 that relies on the control rods that control the reactor power.

The branched off steam line 33 will be fed into a specially designed turbine 1 uniquely added for this invention. The turbine 1 is connected to a special generator 2 that produces electricity by the motion of the generator. The turbine 1 and the generator 2 are utilizing the steam generated by the decay heat to generate electricity such that the station blackout would never occur in a nuclear power plant.

The generator 2 that produces electricity is connected to an array arrangement 41. The electricity is then distributed by the array arrangements to the direct current (DC) buses 3 and the alternating current (AC) buses 4 for the electric equipments used in the plants.

### Embodiment 3

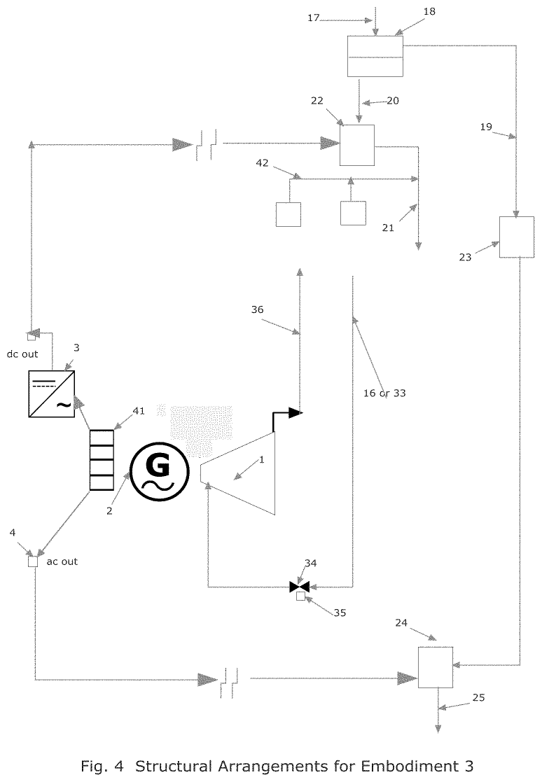

The unique devices and equipment for this invention are described by this embodiment as shown in FIG. 4. The turbine 1 is connected to a special generator 2 that produces electricity by the motion of the generator. The turbine 1 and the generator 2 are utilizing the steam generated by the decay heat to generate electricity such that the station blackout would never occur in a nuclear power plant.

The generator 2 that produces electricity is connected to an array arrangement 41. The electricity is then distributed by the array arrangements to the direct current (DC) buses 3 and the alternating current (AC) buses 4 for the electric equipments used in the plants. Normally during non-accident conditions, when a nuclear power plant is shutdown, the offsite power lines 17 are utilized to deliver power for the onsite use to run safety and non-safety equipments and devices. The offsite power 17 will go through a general control 20 and get converted to the direct current (DC) for onsite use with the connections to the DC buses 21. The general control will also branch off 18 the offsite AC power to the onsite AC power buses 19 through a connecting controls 23, 24 and distributes AC power to safety and non-safety equipments and devices 25.

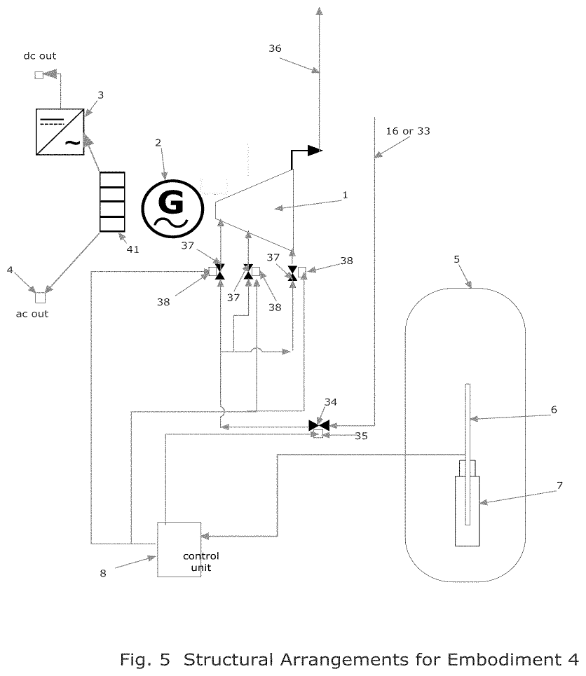

When the reactor is shutdown, the decay heat presented at the beginning in the reactor is 6% of the full power. As time progresses, the decay heat will be decreasing. The decreasing characteristics is shown in FIG. 5. To compensate the less production of electricity at later time by this invention, rechargeable batteries 42 are used to store the higher electricity production at early stage using this invention.

### Embodiment 4

The unique devices and equipment for this invention are described by this embodiment as shown in FIG. 5. The turbine 1 is connected to a special generator 2 that produces electricity by the motion of the generator. The turbine 1 and the generator 2 are utilizing the steam generated by the decay heat to generate electricity such that the station blackout would never occur in a nuclear power plant. The electricity is distributed by the array arrangements to the direct current (DC) buses 3 and the alternating current (AC) buses 4 for the electric equipments used in the plants.

The turbine 1 takes the steam delivered from a branched off steam line 16, 33 that is connected to the main steam line (not shown.) The steam is delivered to the turbine 1 through a multistage arrangement. This arrangement consists of several valves 37 and their associated controls 38 with a main valve 34 upstream of the steam line. Such main valve is controlled by a special control 35 that takes signals from a signal control switch 8. The signal controls switch 8 takes signals from the reactor control rod drives as the operations of this invention is initiated when the reactor is shutdown. The control unit 8 can be overridden by an external signal to begin the operations of this invention, a separate and isolated turbine and generator unit to produce electricity on site when all planned and installed power becomes unavailable.

1. A nuclear power plant including major pieces of equipments: a separate and special steam turbine that has less the capacity of the main steam turbine; and a separate and special electricity generator connected to the said turbine that has less the capacity of the main generator; a steam line branched off the main steam line furnishing the steam to drive the said turbine; a relay arrangement connected to the said generator; a direct current conversion equipment connected to the said relay arrangement; an alternating current equipment connected to the said relay arrangement.

2. The nuclear power plant according to claim 1, comprising a valve in the said branched off steam line with a control device taking signal from a control signal switch, the said control signal switch takes signals generated by the reactor control rod positions.

3. The nuclear power plant according to claim 1, comprising a power relay control switch connected to the said direct current conversion equipment and connected to the offsite power line of converted direct current to deliver direct current to the plant direct current buses.

4. The nuclear power plant according to claim 3, comprising rechargeable batteries that connected to the said power control switch.

5. The nuclear power plant according to claim 1, comprising control valves for diverting steam from the said branched off stem line to the said steam turbine through a multistage arrangement considering the various levels of stem flows.

6. The nuclear power plant according to claim 5, comprising controls that delivering signals for the open sizes for the said control valves for modulating the steam flows from the said branched off steam line through the said multistage arrangement.

7. The nuclear power plant according to claim 1, the said branched off steam line branched off the main steam line furnishing the steam to drive the said turbine such that the steam is produced from the decay heat as the residual heat generated by the nuclear reactor core after shutdown.
